(19) United States
(12) Patent Application Publication
(10) Pub. No.: US 2025/0245428 A1
(43) Pub. Date: Jul. 31, 2025

(54) DYNAMICALLY GENERATING DESCRIPTIONS FOR ITEM GROUPINGS USING A MULTI-MODAL LARGE-LANGUAGE MODEL

(71) Applicant: Maplebear Inc., San Francisco, CA (US)

(72) Inventors: Vinesh Reddy Gudla, South San Francisco, CA (US); Tejaswi Tenneti, San Carlos, CA (US)

(21) Appl. No.: 19/041,590

(22) Filed: Jan. 30, 2025

Related U.S. Application Data
(60) Provisional application No. 63/626,975, filed on Jan. 30, 2024.

(51) Int. Cl. G06F 40/20; G06F 16/338; G06F 16/383

(52) U.S. Cl. CPC G06F 40/20; G06F 16/338; G06F 16/383

(57) ABSTRACT

To balance deficiencies between large-language models (LLM) and machine-learning models, an online system uses a query specificity score to dynamically determine an appropriate model for generating item groupings for a received search query. The query specificity score is a score that measures the specificity of a search query. If the query specificity score is below a threshold, the online system utilizes an LLM to determine a description of a pre-generated item grouping associated with the search query. If the query specificity score is below a threshold, the online system utilizes an LLM to generate a set of item groupings and a description of the generated item groupings. The computed query specificity score enables the online system to dynamically identify which search queries can be effectively addressed using an LLM.

### CROSS REFERENCE TO RELATED APPLICATIONS

This application claims the benefit of U.S. Provisional Patent Application Ser. No. 63/626,975, filed Jan. 30, 2024, which is incorporated by reference herein in its entirety.

### BACKGROUND

Large language models (LLMs) are useful for generating human-like text and handling a diverse set of inputs. LLMs are trained on vast, diverse datasets to capture general language patterns, to provide coherent and contextually relevant responses. LLMs are optimal in tasks requiring creativity and processing unstructured data. While LLMs perform effectively with tasks involving a more general understanding of the data, LLMs struggle with tasks that require a deep understanding of the data and relationships within the data. For example, while LLMs can generally summarize information from larger datasets or generate creative outputs like poems or recipes, they are often ineffective at analyzing data to extrapolate patterns from the data. In fact, this problem is often called a “hallucination problem.”

Rather than using an LLM, computing systems may use specialized machine-learning models that are tailored to detect certain relationships within received datasets and thus may be optimized for tasks requiring a deep understanding of the data. These specialized machine-learning models are better than LLMs for tasks involving a deep understanding of the data as they can be trained based on labeled data to specifically identify the relationships needed for the application at issue. However, these models are ineffective at being creative with their output and generally require very structured inputs. Specialized machine-learning models may lack broader contextual understanding limiting the performance in tasks requiring creativity combining context from several datasets.

Both specialized machine-learning models and LLMs offer distinct advantages and limitations depending on their application. One area where this tradeoff arises is in the context of dynamically creating and describing item groupings. Item groupings include a set of items to be displayed to a user as a group alongside a description of the items in the group. However, dynamically generating these groupings and descriptions requires an understanding of items and their attributes. Thus, neither LLMs nor specialized machine-learning models are effective technical solutions to dynamically generating item groupings.

### SUMMARY

To balance the deficiencies in LLMs and in traditional machine-learning models, an online system uses a query specificity score to determine whether to use an LLM to dynamically generate the full item groupings to display to a user or whether to use pre-generated item groupings and simply use the LLM to dynamically generate their descriptions.

An online system receives a search query associated from a client device and computes a query specificity score for that query. The query specificity score is a score that measures the specificity of a search query. If the query specificity score is below a threshold, the online system utilizes an LLM to determine a description of a pre-generated item grouping associated with the received search query. If the query specificity score is above a threshold, the online system utilizes an LLM to determine a set of item groupings and descriptions of the item groupings associated with the received search query.

Where the query specificity score for a search query exceeds a threshold, the online system generates a dynamic description for an item grouping. The online system identifies an item grouping associated with the search query and generates a prompt to the LLM to generate a dynamic description of the item grouping. In one embodiment, the prompt to the LLM includes instructions to identify candidate items for which a subset of the item grouping is selected for the user. The online system transmits the prompt to the LLM and receives a response from the LLM including the identified item grouping, the generated dynamic description of the item grouping, and the identified candidate items.

Where the query specificity score is below a threshold, the online system generates an item grouping and a dynamic description for the item grouping. The online system generates a prompt the LLM to generate an item grouping and a dynamic description of the item grouping. In one embodiment, the prompt to the LLM includes instructions to identify candidate items for which a subset of the item grouping is selected for the user. The online system transmits the prompt to the LLM and receives a response from the LLM including the generated item grouping, the generated dynamic description of the item grouping, and the identified candidate items.

By moderating the tasks that are delegated to the LLM, the online system improves the technical field of machine-learning-based dynamic content generation. Specifically, the computed query specificity score enables the online system to identify which queries can be effectively addressed using an LLM versus those that require the use of pre-generated item groupings. Thus, the described online system minimizes the deficiencies of LLMs while still taking advantage of their creative abilities.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3 presents an example data flow through an item grouping module, in accordance with some embodiments.

FIG. 4 illustrates an example user interface that may be presented to a user of the online system, in accordance with some embodiments.

FIG. 5 is a flowchart for a method of selecting a process for presenting item groupings with dynamic descriptions, in accordance with some embodiments.

### DETAILED DESCRIPTION

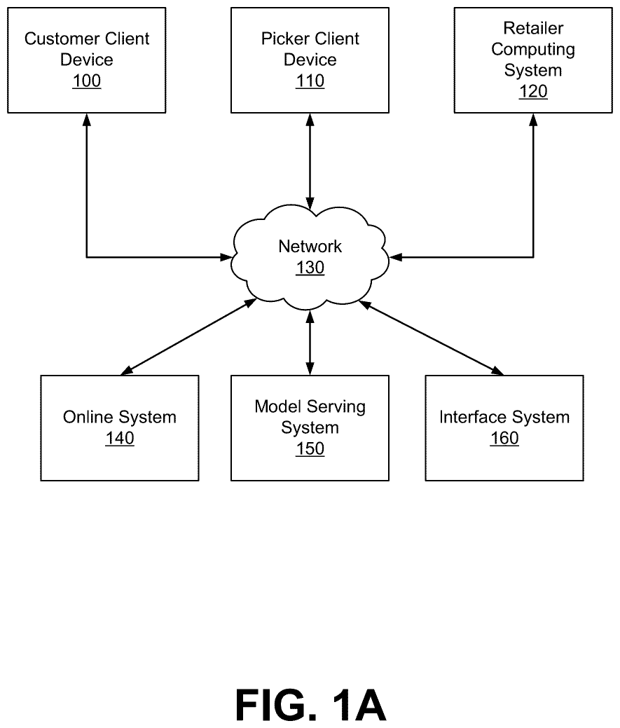

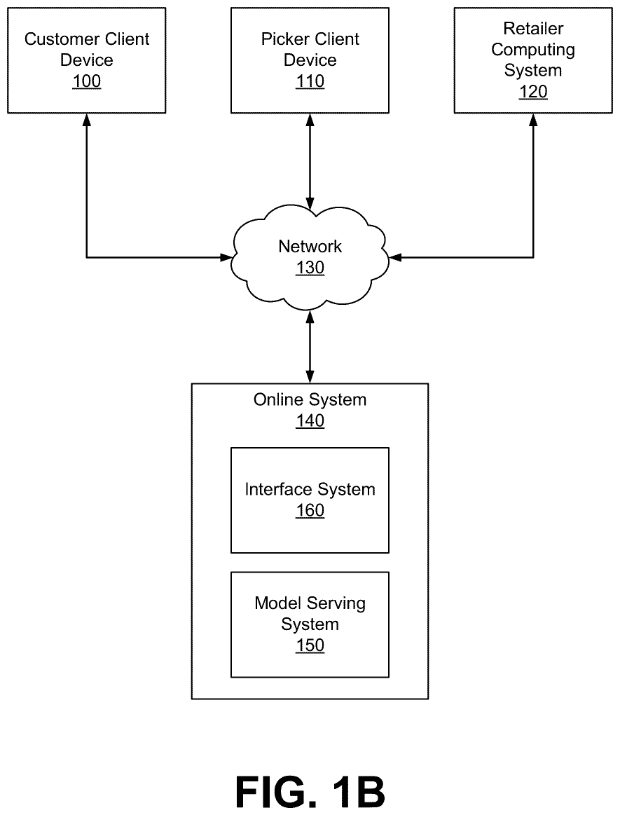

FIG. 1A illustrates an example system environment for an online system 140, in accordance with one or more embodiments. The system environment illustrated in FIG. 1A includes a customer client device 100, a picker client device 110, a retailer computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online system 140. Additionally, while one customer client device 100, picker client device 110, and retailer computing system 120 are illustrated in FIG. 1A, any number of customers, pickers, and retailers may interact with the online system 140. As such, there may be more than one customer client device 100, picker client device 110, or retailer computing system 120.

The customer client device 100 is a client device through which a customer may interact with the picker client device 110, the retailer computing system 120, or the online system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online system 140.

A customer uses the customer client device 100 to place an order with the online system 140. An order specifies a set of items to be delivered to the customer. An “item”, as used herein, means a good or product that can be provided to the customer through the online system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online system 140. The ordering interface may be part of a client application operating on the customer client device 100. The ordering interface allows the customer to search for items that are available through the online system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the customer client device 100 for display to the customer such that the customer can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi-or fully-autonomous robot may collect items in a retailer location for an order and an autonomous vehicle may deliver an order to a customer from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 provides item data indicating which items are available at a retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a user's order (e.g., as a commission).

The customer client device 100, the picker client device 110, the retailer computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which customers can order items to be provided to them by a picker from a retailer. The online system 140 receives orders from a customer client device 100 through the network 130. The online system 140 selects a picker to service the customer's order and transmits the order to a picker client device 110 associated with the picker. The picker collects the ordered items from a retailer location and delivers the ordered items to the customer. The online system 140 may charge a customer for the order and provide portions of the payment from the customer to the picker and the retailer.

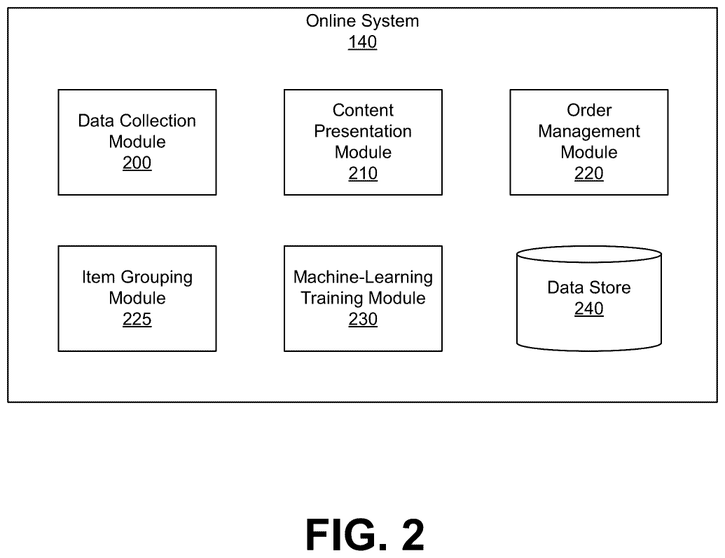

As an example, the online system 140 may allow a customer to order groceries from a grocery store retailer. The customer's order may specify which groceries they want delivered from the grocery store and the quantities of each of the groceries. The customer's client device 100 transmits the customer's order to the online system 140 and the online system 140 selects a picker to travel to the grocery store retailer location to collect the groceries ordered by the customer. Once the picker has collected the groceries ordered by the customer, the picker delivers the groceries to a location transmitted to the picker client device 110 by the online system 140. The online system 140 is described in further detail below with regards to FIG. 2.

The model serving system 150 receives requests from the online system 140 to perform tasks using machine-learned models. The tasks include, but are not limited to, natural language processing (NLP) tasks, audio processing tasks, image processing tasks, video processing tasks, and the like. In one embodiment, the machine-learned models deployed by the model serving system 150 are models configured to perform one or more NLP tasks. The NLP tasks include, but are not limited to, text generation, query processing, machine translation, chatbots, and the like. In one embodiment, the language model is configured as a transformer neural network architecture. Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one embodiment, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 140 or one or more entities different from the online system 140. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

In one embodiment, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

In one embodiment, the online system 140 prompts a model serving system to identify ingredients in images of dishes or recipes received from a user's client device. Specifically, the online system 140 prepares a prompt for input to the model serving system 150. The online system 140 receives a response to the prompt from the model serving system 150 based on execution of the machine-learned model using the prompt. The online system 140 obtains the response and updates stored user data describing the user based on the identified ingredients.

In one embodiment, the task for the model serving system 150 is based on knowledge of the online system 140 that is fed to the machine-learned model of the model serving system 150, rather than relying on general knowledge encoded in the model weights of the model. Thus, one objective may be to perform various types of queries on the external data in order to perform any task that the machine-learned model of the model serving system 150 could perform. For example, the task may be to perform question-answering, text summarization, text generation, and the like based on information contained in an external dataset.

Thus, in one embodiment, the online system 140 is connected to an interface system 160. The interface system 160 receives external data from the online system 140 and builds a structured index over the external data using, for example, another machine-learned language model or heuristics. The interface system 160 receives one or more queries from the online system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses from the model serving system 160 and synthesizes a response to the query on the external data. While the online system 140 can generate a prompt using the external data as context, often times, the amount of information in the external data exceeds prompt size limitations configured by the machine-learned language model. The interface system 160 can resolve prompt size limitations by generating a structured index of the data and offers data connectors to external data sources.

FIG. 1B illustrates an example system environment for an online system 140, in accordance with one or more embodiments. The system environment illustrated in FIG. 1B includes a customer client device 100, a picker client device 110, a retailer computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 is managed by a separate entity from the online system 140. In one embodiment, as illustrated in the example system environment in FIG. 1B, the model serving system 150 and/or the interface system 160 is managed and deployed by the entity managing the online system 140.

FIG. 2 illustrates an example system architecture for an online system 140, in accordance with some embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

In some embodiments, the data collection module 200 collects contextual data. The contextual data is data that describes a context for a user's interaction with the online system. For example, the contextual data may describe the user's current session with the online system, such as items that the user has viewed through the client device in this session, search queries that the user has entered in the session, or items that the user has already added to an item list for an order. Contextual data also may include data such as consumer behavior, market trends, seasonality, and social media analytics.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has services orders for the online system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and offers the orders to pickers for service based on picker data. For example, the order management module 220 offers an order to a picker based on the picker's location and the location of the retailer from which the ordered items are to be collected. The order management module 220 may also offer an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to offer an order to a picker based on a delivery timeframe requested by the customer with the order. The order management module 220 computes an estimated amount of time that it would take for a picker to collect the items for an order and deliver the ordered item to the delivery location for the order. The order management module 220 offers the order to a picker at a time such that, if the picker immediately services the order, the picker is likely to deliver the order at a time within the timeframe. Thus, when the order management module 220 receives an order, the order management module 220 may delay in offering the order to a picker if the timeframe is far enough in the future.

When the order management module 220 offers an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The item grouping module 225 generates descriptions of item groupings using a large language model (e.g., of the model serving system 150). An item grouping is a set of items that are related to each other based on a theme. For example, an item grouping may be items that are related to a holiday, relevant to an activity, or share some characteristic (e.g., healthy or vegetarian). A description for an item grouping is text that describes the theme to which the set of items relate. For example, a description of an item grouping may be a title or a short paragraph that explains to a user what the theme for the item grouping is.

To generate a description of an item grouping, the item grouping module 225 accesses user data stored by the online system. User data is data describing characteristics of a user. For example, user data may comprise of data describing the user's demographics and the user's interactions with the online system 140. The item grouping module 225 may also access contextual data describing a user's session with the online system. For example, the contextual data describing may describe which items a user has interacted with during the session or search queries that have been entered by the user.

The item grouping module 225 accesses grouping data for an item grouping for which the item grouping module 225 is generating a description. Item grouping data is data describing the item grouping. For example, the grouping data may include an indication of the theme of the item grouping or item data describing items in a set of candidate items for the item grouping.

In one or more embodiments, a specialized machine-learning model generates an item grouping. The set of candidate items for an item grouping are a set of items from which the online system may select a subset to be displayed to the user on the client device associated with the user. The set of candidate items may be manually generated by operators of the online system or may be automatically generated based on order history data of which items are ordered together and when.

In some embodiments, to present an item grouping to a user, the item grouping module 225 may select a subset of the set of candidate items to present as part of the item grouping. For example, the item grouping module 225 may select a subset of candidate items to present to a user as an item grouping based on user data describing the user (e.g., a user embedding) and item data describing each item in the set of candidate items of the item grouping (e.g., item embeddings).

The item grouping module 225 generates an input prompt for a LLM of the model serving system 150. The input prompt instructs the LLM to generate a description for the item grouping based on the user data and the item grouping data. In some embodiments, the input prompt also includes contextual data accessed by the item grouping module 225. The input prompt may also specify parameters for the description, such as what kind of description to generate (title vs. short summary) or how long the description should be (e.g., how many words).

As noted above, the item grouping module 225 may select a subset of candidate items to present to the user in the item grouping, and the input prompt may include an indication of which candidate items in the item grouping are included in the subset to be displayed to a user. Alternatively, the input prompt may instruct the LLM to select the subset of candidate items. For example, the input prompt may instruct the LLM to score each candidate item based on whether the candidate item is one that the user may be interested in. In some embodiments, the input prompt instructs the LLM to generate an output that is of a JSON structure or another data structure format.

The item grouping module 225 receives a response from the LLM. The received response includes a description for the item grouping to be displayed with a subset of the set of candidate items. In embodiments where the input prompt requests that the LLM select a subset of candidate items to present as the item grouping, the response indicates which content items the LLM has selected. For example, the response may list the subset of candidate items to present as the item grouping or may list scores for each of the set of candidate items. The online system presents the subset of candidate items and the generated description for presentation through a user interface to the user. The user can interact with the items through the user interface (e.g., select the items for an order).

In some embodiments, rather than providing item groupings to the LLM through the prompt, the input prompt requests that the LLM generate item groupings based on a set of items that can be used. For example, the item grouping module 225 may provide item data for a set of items available from a retailer in the input prompt and user data describing a user to which the item grouping module 225 will present item groupings. The input prompt may instruct the LLM to generate a set of item groupings based on the provided items and the user data and a corresponding description for each of the item groupings. The item grouping module 225 receives a response from the LLM indicating which items should be listed in which item grouping and a corresponding description to provide with each item grouping. The item grouping module 225 may present these generated item groupings to the user through a user interface as described above.

In one embodiment, the item grouping module 225 receives feedback from the presented user interface to the user. For example, feedback from the user may be that the user selects the generated item grouping and the corresponding description for the generated item grouping. The item grouping module 225 may use the received user feedback in future prompts to the LLM to improve the responses from the LLM.

In some embodiments, the item grouping module 225 dynamically selects a method for generating item groupings to present to a user based on the search query that the user inputs. In particular, the item grouping module 225 computes a query specificity score for each search query. If the query specificity score is below a threshold, the item grouping module 225 uses an LLM to generate dynamic descriptions of pre-generated item groupings based on the search query. If the query specificity score exceeds a threshold, the item grouping module 225 uses the LLM to dynamically generate both a set of item groupings to present to a user and generates the descriptions of the item groupings.

To do this dynamic selection, the item grouping module 225 computes a query specificity score based on the free text of the search query. A query specificity score is a score that measures the specificity of a search query. For example, the query specificity score may represent how many different items could be reasonably provided as search results in response to the search query.

The item grouping module 225 may compute the query specificity score based on a query breadth score. A query breadth score represents the breadth of the free text in the received search query. For example, a specific search query (e.g., “red leather shoes size 9”) may have a lower query breath score than a broad or ambiguous search query (e.g., “shoes”). In some embodiments, the query breadth score may be computed by computing an entropy score for the inputted search query. The entropy score functions as an inverse measure of specificity for the search query and, as such, its inverse may be used as the query specificity score. The item grouping module 225 may compute the entropy score by computing, for a set of possible interaction outcomes from the search query, an uncertainty of which interaction outcomes may result. An interaction outcome is an outcome that represents an interaction between a user and an item presented in search results for the search query. An uncertainty in interaction outcomes may be based on historical data, such as data describing which items users with the same or similar queries have interacted with in the past, or data showing the rate at which users have interacted with a particular item when it has been presented in response to a search query. For example, for a given search query, the item grouping module 225 may obtain data indicative of counts of historical conversions for each of a set of different items resulting from the search query as applied to an item database. The item grouping module 225 computes the entropy score using probabilities that a customer will interact with an item, given a search query, where the item grouping module 225 computes the probabilities based on historical data. U.S. patent application Ser. No. 18/241,093, entitled “Ranking Search Results Based on Appeasement Signals and Query Specificity” and filed Aug. 31, 2023, describes additional details of computing a query breadth score and is incorporated by reference.

A query frequency score represents how often a search query is submitted over a given time period. For example, if the search query “fruit” is submitted 100 times over a given time period while a search query “granny smith apples” is submitted 3 times over the given time period, the “fruit” query may have a higher query frequency score than the other search query.

The item grouping module 225 may compute a query frequency score for a query by computing the number of times that the query is received over a time period. For example, the item grouping module 225 may maintain a rolling count for each query of how many times that query has been received over a rolling time period. This count may be an absolute count over the time period. Similarly, the count may be relative to the total number of search queries received over the given time period. For example, the count per query may be a relative percentage of the total queries received that had that particular query. In some embodiments, the query frequency score may be normalized over the given time period by scaling the computed count of the received search query over an average count of a search query.

In one embodiment, the query specificity score is computed by determining a weighted combination of the query breadth score and the query frequency score. As an example, the item grouping module 225 may assign a first weight to the computed query breadth score and a second weight to the computed query frequency score. The query specificity score may then be computed by applying the first weight to the query breadth score and the second weight to the query frequency score.

As noted above, the item grouping module uses a query specific score computed for a search query to determine how to generate item groupings to present to a user. To determine which approach to take, the item grouping module 225 determines whether a query's computed query specificity score exceeds a threshold. If the query specificity score exceeds a threshold (e.g., the search query is narrow or is infrequently received), the item grouping module 225 generates the item groupings for the search query by prompting an LLM to generate an item grouping and description for the item grouping. If the query specificity score is below the threshold (e.g., the search query is broad or is frequently received), the item grouping module 225 uses an LLM to generate descriptions for item groupings that are stored by the online system.

The machine learning training module 230 trains machine learning models used by the online system 140. For example, the machine learning module 230 may train the item selection model, the availability model, or any of the machine-learned models deployed by the model serving system 150. The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 230 updates the set of parameters for the machine learning model based on the score generated by the loss function. For example, the machine learning training module 230 may apply gradient descent to update the set of parameters.

The data store 240 stores data used by the online system 140. For example, the data store 240 stores customer data, item data, order data, and picker data for use by the online system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

With respect to the machine-learned models hosted by the model serving system 150, the machine-learned models may already be trained by a separate entity from the entity responsible for the online system 140. In another embodiment, when the model serving system 150 is included in the online system 140, the machine-learning training module 230 may further train parameters of the machine-learned model based on data specific to the online system 140 stored in the data store 240. As an example, the machine-learning training module 230 may obtain a pre-trained transformer language model and further fine tune the parameters of the transformer model using training data stored in the data store 240. The machine-learning training module 230 may provide the model to the model serving system 150 for deployment.

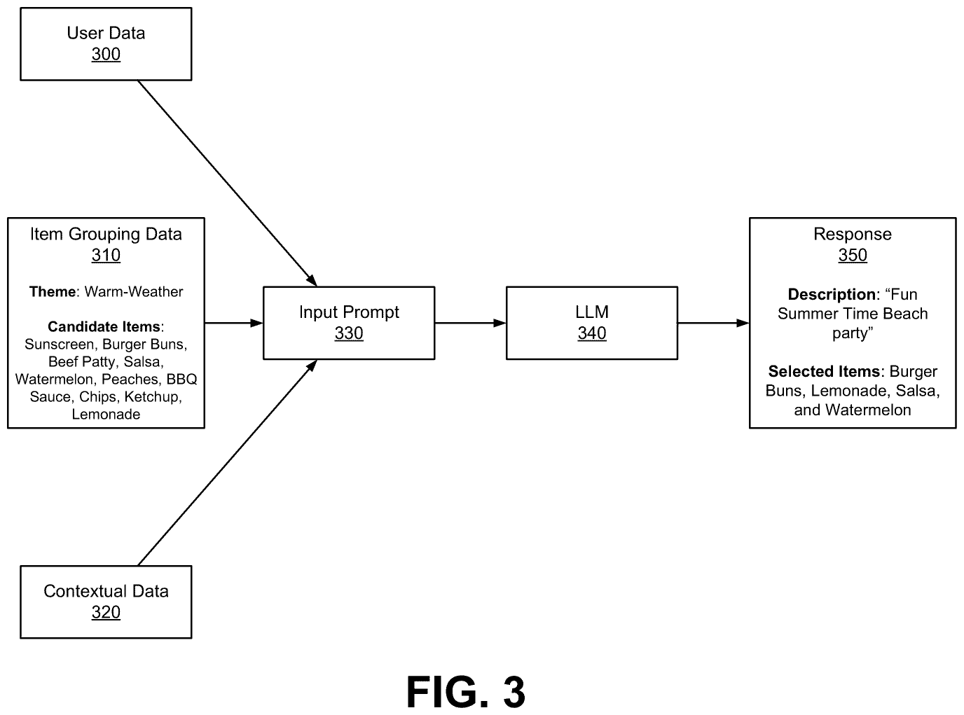

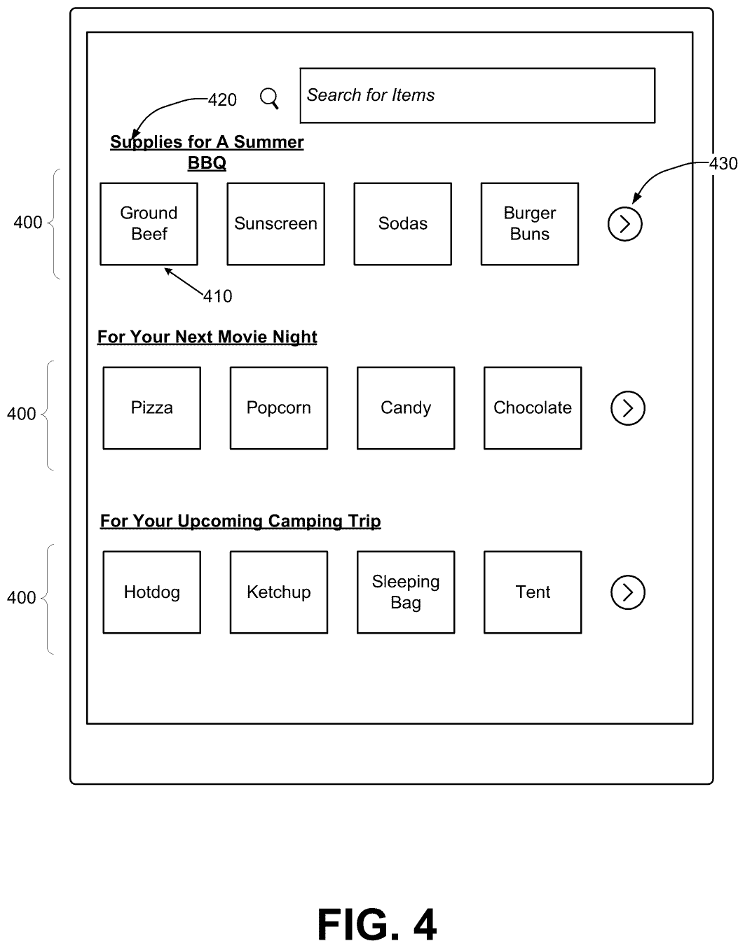

FIG. 3 presents an example data flow through an item grouping module 225, in accordance with some embodiments. The system environment illustrated in FIG. 4 includes user data 300, item grouping data 310, contextual data 320, input prompt 330, LLM 340, and a response 350. In FIG. 3, the item grouping data 310 has a theme indicator that indicates a theme of the candidate items in the item grouping data. The item grouping data 310 also includes a set of candidate items that may be included in an item grouping presented to a user. The item grouping module generates an input prompt 330 based on the item grouping data 310, user data 300, and contextual data 320. The input prompt 330 is transmitted to the multi-modal LLM 340 and the multi-modal LLM generates a response 350. The response 350 comprises an item grouping description describing the theme in the item grouping data 310. The response 350 also includes a subset of the set of candidate items included in the item grouping data 310. The item grouping module 225 may present a user interface to the user that includes the item grouping. The item grouping may be presented with the generated description and the selected subset of candidate items.

FIG. 4 illustrates an example user interface that may be presented to a user of the online system 140, in accordance with some embodiments. The interface presents item groupings 400 with items 410 with which the user can interact. Each item grouping 400 includes an item grouping description 420. The user interface may further include an element allowing a user to view other candidate items that are associated with each item grouping.

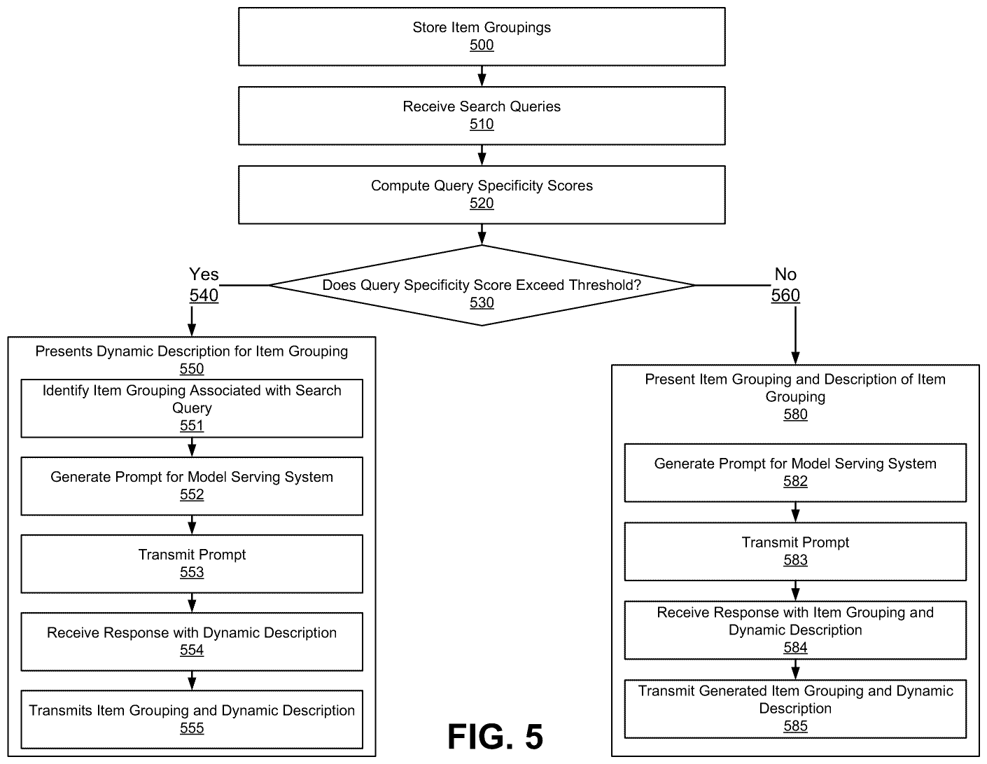

FIG. 5 is a flowchart for a method of selecting a process for presenting item groupings with dynamic descriptions, in accordance with some embodiments. Alternative embodiments may include more, fewer, or different steps, and the steps may be performed in a different order from that illustrated in FIG. 5. Furthermore, while FIG. 5 is described below as being performed by an item grouping module of an online system, some or all of the steps may be performed by different components of an online system or other devices in communication with an online system, such as a client device. In one embodiment, a similar method may be performed to present item filters, item badges, carousels, or carousel titles.

The item grouping module 225 stores 500 item groupings. The item grouping module 225 receives 510 a plurality of search queries from users of client devices. The item grouping module 225 computes 520 a query specificity score for each search query of the plurality of search queries. The item grouping module 225 determines 530, for each search query of the plurality of search queries, whether the query specificity score exceeds a threshold value. The item grouping module 225 determines 540, for a first subset of the plurality of search queries, that the corresponding query specificity score exceeds a threshold value. The item grouping module 225 presents 550, for each search query in the first subset of search queries, a description of an item grouping associated with the search query. The item grouping module 225 presents the item groupings for the first subset of search queries by identifying 551 an item grouping associated with the search query. The item grouping module 225 generates 552 a prompt for a LLM, wherein the prompt includes instructions to generate a description of the item grouping. The item grouping module 225 transmits 553 the prompt to the LLM. The item grouping module 225 receives 554 a response from the LLM including the generated dynamic description of the item grouping. The item grouping module 225 transmits 555 the identified item grouping and the dynamic description of the item grouping to the user.

The item grouping module 225 determines 560, for a second subset of the plurality of search queries, that the corresponding query specificity scores are below a threshold value. The item grouping module 225 presents 580, for each search query in the second subset of search queries, an item grouping and a dynamic description of the generated item grouping. The item grouping module 225 generates 582 a prompt for a LLM, wherein the prompt includes instructions to generate the item grouping and a description of the item grouping. The item grouping module 225 transmits 583 the prompt to the LLM. The item grouping module 225 receives 584 a response from the LLM including the item grouping and the description of the generated item grouping. The item grouping module 225 transmits 585 the generated item grouping and the dynamic description of the item grouping to the user.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A computer-implemented method, comprising:
storing, by an online system, a plurality of item groupings, wherein each item grouping comprises a set of items and wherein each item grouping is associated with a set of search queries;
receiving a plurality of search queries from users of client devices, wherein each search query comprises free text describing items to retrieve from an item database;
computing a query specificity score for each search query of the plurality of search queries based on the corresponding free text of the corresponding search query;
determining, for a first subset of the plurality of search queries, that the corresponding query specificity scores are above a threshold value;
determining, for a second subset of the plurality of search queries, that the corresponding query specificity scores are below the threshold value;
presenting, for each search query in the first subset of search queries, a dynamic description for an item grouping to a corresponding user, wherein presenting the dynamic description comprises:
identifying an item grouping of the plurality of item groupings associated with the search query;
generating a prompt for a model serving system, wherein the prompt comprises:
user data describing a user associated with the search query;
the identified item grouping; and
instructions to generate a dynamic description for the item grouping based on the user data and the item grouping;
transmitting the prompt to the model serving system;
receiving a response from the model serving system, wherein the response comprises the dynamic description for the item grouping; and
transmitting the identified item grouping and the dynamic description of the item grouping to a client device of the user for presentation to the user; and
presenting, for each search query in the second subset of search queries, a dynamic item grouping by:
generating a prompt for the model serving system, wherein the prompt comprises:
user data describing a user associated with the search query;
item data describing a plurality of candidate items;
instructions to generate an item grouping to display to the user based on the user data and the item data; and
instructions to generate a description for the item grouping based on the user data and the item data;
transmitting the prompt to the model serving system;
receiving a response from the model serving system, wherein the response comprises the generated item grouping and the generated description for the item grouping; and
transmitting the item grouping and the description of the item grouping to a client device of the user for presentation to the user.

2. The computer-implemented method of claim 1, wherein computing the query specific score for a search query comprises:
computing a query breadth score based on the search query that represents a breadth of the free text in the search query.

3. The computer-implemented method of claim 2, wherein computing the query breadth score for a search query comprises:
computing an entropy score, wherein the entropy score is an inverse measure of a specificity of the search query.

4. The computer-implemented method of claim 1, wherein computing the query specificity score for a search query comprises:
computing a frequency score based on the search query, wherein the frequency score represents a number of times that the search query is received over a time period.

5. The computer-implemented method of claim 4, wherein computing the frequency score for a search query comprises:
computing a percentage of a total number of queries received over the time period were the search query.

6. The computer-implemented method of claim 1, wherein computing the query specificity score comprises computing a weighted combination of a set of sub-scores.

7. The computer-implemented method of claim 1, wherein the user data describing the user associated with a search query in the first subset or second subset of search queries comprises user interaction data describing an interaction of the user with an item of the online system, user location data describing a location of the user, or user order information describing an order associated with the user.

8. The computer-implemented method of claim 1, wherein each item grouping in the stored plurality of item groupings comprises an indication of a theme associated with the item grouping.

9. The computer-implemented method of claim 8, wherein the instructions to generate the dynamic description of an item grouping for a search query in the first subset of search queries comprise:
instructions to generate the description based on the theme associated with the item grouping.

10. The computer-implemented method of claim 1, wherein the instructions to generate a dynamic description of an item grouping for a search query in the first subset or second subset of search queries comprises instructions to generate a title or paragraph describing the item grouping.

11. A non-transitory computer-readable medium storing instructions that, when executed by a computer system, cause the computer system to perform operations comprising:
storing, by an online system, a plurality of item groupings, wherein each item grouping comprises a set of items and wherein each item grouping is associated with a set of search queries;
receiving a plurality of search queries from users of client devices, wherein each search query comprises free text describing items to retrieve from an item database;
computing a query specificity score for each search query of the plurality of search queries based on the corresponding free text of the corresponding search query;
determining, for a first subset of the plurality of search queries, that the corresponding query specificity scores are above a threshold value;
determining, for a second subset of the plurality of search queries, that the corresponding query specificity scores are below the threshold value;
presenting, for each search query in the first subset of search queries, a dynamic description for an item grouping to a corresponding user, wherein presenting the dynamic description comprises:
identifying an item grouping of the plurality of item groupings associated with the search query;
generating a prompt for a model serving system, wherein the prompt comprises:
user data describing a user associated with the search query;
the identified item grouping; and
instructions to generate a dynamic description for the item grouping based on the user data and the item grouping;
transmitting the prompt to the model serving system;
receiving a response from the model serving system, wherein the response comprises the dynamic description for the item grouping; and
transmitting the identified item grouping and the dynamic description of the item grouping to a client device of the user for presentation to the user; and
presenting, for each search query in the second subset of search queries, a dynamic item grouping by:
generating a prompt for the model serving system, wherein the prompt comprises:
user data describing a user associated with the search query;
item data describing a plurality of candidate items;
instructions to generate an item grouping to display to the user based on the user data and the item data; and
instructions to generate a description for the item grouping based on the user data and the item data;
transmitting the prompt to the model serving system;
receiving a response from the model serving system, wherein the response comprises the generated item grouping and the generated description for the item grouping; and
transmitting the item grouping and the description of the item grouping to a client device of the user for presentation to the user.

12. The computer-readable medium of claim 11, wherein computing the query specific score for a search query comprises:
computing a query breadth score based on the search query that represents a breadth of the free text in the search query.

13. The computer-readable medium of claim 12, wherein computing the query breadth score for a search query comprises:
computing an entropy score, wherein the entropy score is an inverse measure of a specificity of the search query.

14. The computer-readable medium of claim 11, wherein computing the query specificity score for a search query comprises:
computing a frequency score based on the search query, wherein the frequency score represents a number of times that the search query is received over a time period.

15. The computer-readable medium of claim 14, wherein computing the frequency score for a search query comprises:
computing a percentage of a total number of queries received over the time period were the search query.

16. The computer-readable medium of claim 11, wherein computing the query specificity score comprises computing a weighted combination of a set of sub-scores.

17. The computer-readable medium of claim 11, wherein the user data describing the user associated with a search query in the first subset or second subset of search queries comprises user interaction data describing an interaction of the user with an item of the online system, user location data describing a location of the user, or user order information describing an order associated with the user.

18. The computer-readable medium of claim 11, wherein each item grouping in the stored plurality of item groupings comprises an indication of a theme associated with the item grouping.

19. The computer-readable medium of claim 18, wherein the instructions to generate the dynamic description of an item grouping for a search query in the first subset of search queries comprise:
instructions to generate the description based on the theme associated with the item grouping.

20. A computer system comprising:
a processor; and
non-transitory computer-readable medium storing instructions that, when executed by the computer system, cause the computer system to perform operations comprising:
storing, by an online system, a plurality of item groupings, wherein each item grouping comprises a set of items and wherein each item grouping is associated with a set of search queries;
receiving a plurality of search queries from users of client devices, wherein each search query comprises free text describing items to retrieve from an item database;
computing a query specificity score for each search query of the plurality of search queries based on the corresponding free text of the corresponding search query;
determining, for a first subset of the plurality of search queries, that the corresponding query specificity scores are above a threshold value;
determining, for a second subset of the plurality of search queries, that the corresponding query specificity scores are below the threshold value;
presenting, for each search query in the first subset of search queries, a dynamic description for an item grouping to a corresponding user, wherein presenting the dynamic description comprises:
identifying an item grouping of the plurality of item groupings associated with the search query;
generating a prompt for a model serving system, wherein the prompt comprises:
user data describing a user associated with the search query;
the identified item grouping; and
instructions to generate a dynamic description for the item grouping based on the user data and the item grouping;
transmitting the prompt to the model serving system;
receiving a response from the model serving system, wherein the response comprises the dynamic description for the item grouping; and
transmitting the identified item grouping and the dynamic description of the item grouping to a client device of the user for presentation to the user; and
presenting, for each search query in the second subset of search queries, a dynamic item grouping by:
generating a prompt for the model serving system, wherein the prompt comprises:
user data describing a user associated with the search query;
item data describing a plurality of candidate items;
instructions to generate an item grouping to display to the user based on the user data and the item data; and
instructions to generate a description for the item grouping based on the user data and the item data;
transmitting the prompt to the model serving system;
receiving a response from the model serving system, wherein the response comprises the generated item grouping and the generated description for the item grouping; and
transmitting the item grouping and the description of the item grouping to a client device of the user for presentation to the user.
